(19) United States
(12) Patent Application Publication
(10) Pub. No.: US 2016/0036060 A1
(43) Pub. Date: Feb. 4, 2016

(54) COMPOSITE ELECTRODE FOR FLOW BATTERY

(71) Applicant: Concurrent Technologies Corporation, Johnstown, PA (US)

(72) Inventors: Paul John Brezovec, Johnstown, PA (US); Timothy Allen Kennedy, Home, PA (US); Michel J. McCluskey, Somerset, PA (US); Daniel R. Markiewicz, Johnstown, PA (US)

(21) Appl. No.: 14/796,531

(22) Filed: Jul. 10, 2015

Related U.S. Application Data
(60) Provisional application No. 62/030,722, filed on Jul. 30, 2014.

(51) Int. Cl. H01M 4/86; H01M 8/20; H01M 8/18

(52) U.S. Cl. CPC H01M 4/8657; H01M 8/188; H01M 8/20; H01M 4/8605

(57) ABSTRACT

A composite electrode adapted for use in a flow battery stack system has a carbon felt stratum forming a semi-porous reaction zone and a carbon foam stratum forming a porous flow path zone. The composite electrode is less compressible than prior art electrodes having similar conductivity and specific surface areas. Flow battery stack systems employing the composite electrode operate with lower feed pressures, experiences a lower pressure drops across the electrodes, and realize improved electrical resistivity. Alternative embodiments provide electrical conductive elements and a current collector disposed on a surface of the composite electrode.

### CROSS-REFERENCE TO RELATED APPLICATIONS

This patent application claims the benefit of co-pending U.S. Provisional Patent Application No. 62/030,722, filed on Jul. 30, 2014, which is hereby incorporated by reference in its entirety.

### FIELD OF THE INVENTION

The present invention is directed generally towards an electrode having a composite construction and, more particularly, to an electrode having a carbon felt stratum forming a semi-porous reaction zone and a carbon foam stratum forming a porous flow path zone.

### BACKGROUND OF THE INVENTION

A flow battery system is a rechargeable fuel cell exploiting the fluid dynamics, kinetics, and chemical potential properties of fluids containing electroactive elements (i.e., electrolytes) to convert chemical energy to electrical energy. The electrolytes typically comprise a catholyte fluid and an anolyte fluid, where each are stored in separate electrolyte tanks. At least one pump for each tank, directs the electrolytes from the electrolyte tanks and into a cell stack (comprising of one or more cells). The electrolytes come into contact with electrodes to generate electrical energy, which is typically stored in current collectors of the cell stack. A load is placed into electrical communication with the cell(s) to selectively draw electrical power from the flow battery system.

Each cell typically comprises a positive electrode disposed on a first side of a membrane and a negative electrode disposed on a second side of a membrane. The membrane facilitates movement of the electroactive elements and the exchange of electric charges. A flow frame substantially encases the electrodes and membrane, and contains the electrolytes as they are directed into, and out from, the cell stack by the pump(s). The flow frame typically comprises two or more members that are configured to compress the cell components together, and are secured together via a fastener, fused together, or otherwise sealed. The flow frame creates a flow compartment within which the cell components are contained, and it is generally provided with inlets and outlets to facilitate fluid communication with a manifold that is in further fluid communication with the tanks.

In systems with multiple cells, a plurality of cells are arranged in electrical series, with each cell being separated by bipolar plates to facilitate passage of electricity while keeping the electrolytes inside. The bipolar plates create flow sub-compartments such that each flow sub-compartment has opposite polarities and contains an electrode of a respective polarity. Monopolar plates are typically disposed at terminal ends of the stack, and the electrodes, monopolar plates, and bipolar plates are in electrical communication with the current collectors.

Performance of these flow battery systems is directly related to internal resistance, current transfer efficiency, the feed pressure of the pumps, and material degradation of the component parts. The electrolytes should generally exhibit high ionization and chemical kinetics and have a low viscosity. The electrodes generally should exhibit resistance to acid, have a high specific surface area, and be good electrical conductors. The membrane generally should enable ion transfer but prevent, or at least inhibit, mixing of the electrolytes and exhibit consistent diffusion and electrical resistivity properties. The flow frame members generally should exhibit resistance to acid, maintain a steady compressive force upon the electrodes and membrane, and adequately contain the electrolytes as well as the component parts.

Prior art in this field consists of flow battery systems employing carbon felt electrodes. Carbon felt is widely used due to its high specific area and high electrical conductivity. Use of carbon felt as the electrodes for the flow battery system, however, poses several problems. Carbon felt must be compressed significantly during assembly of the cell stack to ensure a positive connection is formed between the bipolar/monopolar plate and the membrane. High compression tends to generate bulging and alignment issues when assembling the cell stacks. Highly compressed carbon felt also requires high pump pressure to pump the electrolyte through the carbon felt. In prior art systems, up to 75% of the pressure drop is commonly experienced across the carbon felt electrode. Consequently, yielding efficient electrical properties requires high pressure pumping, but expending energy to do so results in reduced efficiency. Operating at higher pumping pressures also tends to lead to leakage of electrolyte through the flow frame as well.

The present invention is directed toward overcoming one or more of the above-identified problems.

### SUMMARY OF THE INVENTION

The composite electrode in accordance with the present invention includes a composition of carbon felt and carbon foam, which can be in laminate form or created by additive manufacturing. Carbon foam is less compressible, so the composite electrode does not require high compression; thus reduced feed pressures from the pumps can be used to operate the flow battery system. Flow battery stack systems using the composite electrode of the present invention can operate with lower feed pressures, experience a lower pressure drop across the electrodes, and exhibit similar, if not better, electrical resistivity as compared to carbon felt electrodes. This increases efficiency and performance of the flow battery system, as well as reduces the probability failures caused by leakage.

In a preferred embodiment, the composite electrode includes an electrode having a semi-porous reaction zone and a porous flow path zone, where the semi-porous reaction zone includes carbon felt and the porous flow path zone comprises carbon foam. A surface of the carbon foam may be provided with electrically conductive elements, preferably graphene, and a current collector, preferably graphite. One skilled in the art that other layer graphic carbons may be utilized including, but not limited to, graphene, fullerenes, carbon nanotubes, and other materials exhibiting similar properties. The carbon felt is preferably SGL Group carbon electrode felt. Of course other felts from other vendors may be utilized, as will be appreciated by one skilled in the art. The carbon foam is preferably Duecel® reticulated vitreous foam. Of course other foams from other vendors may be utilized, as will be appreciated by one skilled in the art. In one exemplary form, the composite electrode is configured to exhibit at least eighty pores per inch within the porous flow path zone when the composite electrode is compressed within a flow battery stack system.

It is an object of the present invention to provide an electrode having a semi-porous reaction zone comprising carbon felt and a porous flow path zone comprising carbon foam to reduce compression of the composite electrode, thereby enabling flow battery stack systems using the presently disclosed composite electrode to operate with lower feed pressures, experience a lower pressure drops across the electrodes, and/or exhibit improved electrical resistivity.

It is a further object of the present invention to provide electrically conductive elements on a surface of the carbon foam to improve electrical conductivity.

It is a further object of the present invention to provide a current collector on a surface of the carbon foam.

It is a further object of the present invention to configure the composite electrode so that it exhibits at least eighty pores per inch within the porous flow path zone when the composite electrode is compressed within the flow battery stack system.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present invention will be more apparent from the following more particular description thereof, presented in conjunction with the following drawings, in which:

FIG. 1 is a cross-sectional schematic of the composite electrode in accordance with the present invention;

FIG. 2 is a schematic the composite electrode of the present invention being used with a typical flow battery stack system; and,

FIG. 3 is a table depicting test results of observed stack resistance with various thicknesses and pores per inch of carbon felt and carbon foam.

### DETAILED DESCRIPTION OF THE INVENTION

The following description is of an embodiment presently contemplated for carrying out the present invention. This description is not to be taken in a limiting sense, but is made merely for the purpose of describing the general principles and features of the present invention. The scope of the present invention should be determined with reference to the claims.

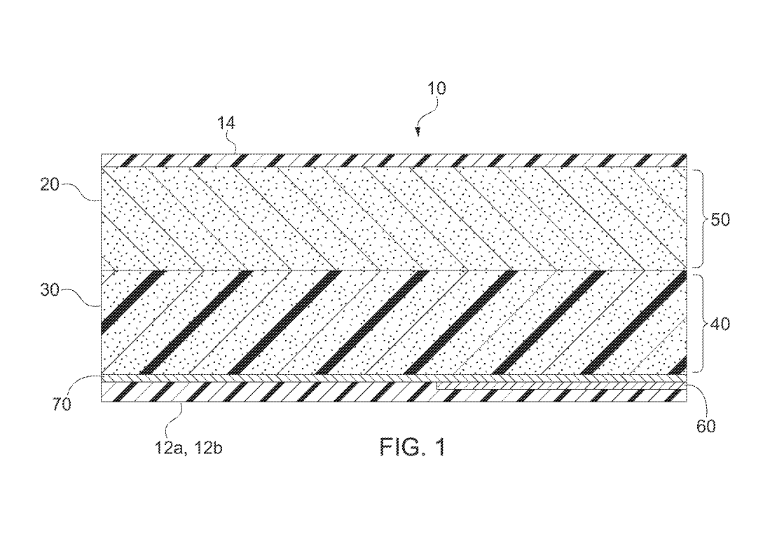

Referring now to FIG. 1, a cross-sectional schematic of the composite electrode 10, in accordance with a preferred embodiment, is disclosed. The composite electrode 10 includes a composition of carbon felt 20 and carbon foam 30. This composite electrode 10 can be manufactured as two or more laminated layers or as a single piece through additive manufacturing or other manufacturing techniques. The carbon felt 20 is preferably carbon electrode felt from the SGL Group. The carbon foam 30 is preferably Duecel® reticulated vitreous foam provided by ERG Aerospace. Of course, one skilled in the art will appreciate that other carbon felts/foams may be utilized without departing from the spirit and scope of the present invention. The composite electrode 10 is configured to have a porous flow path zone 40 and a semi-porous reaction zone 50, where the porous flow path zone 40 comprises the carbon foam 30 and the semi-porous reaction zone 50 comprises the carbon felt 20.

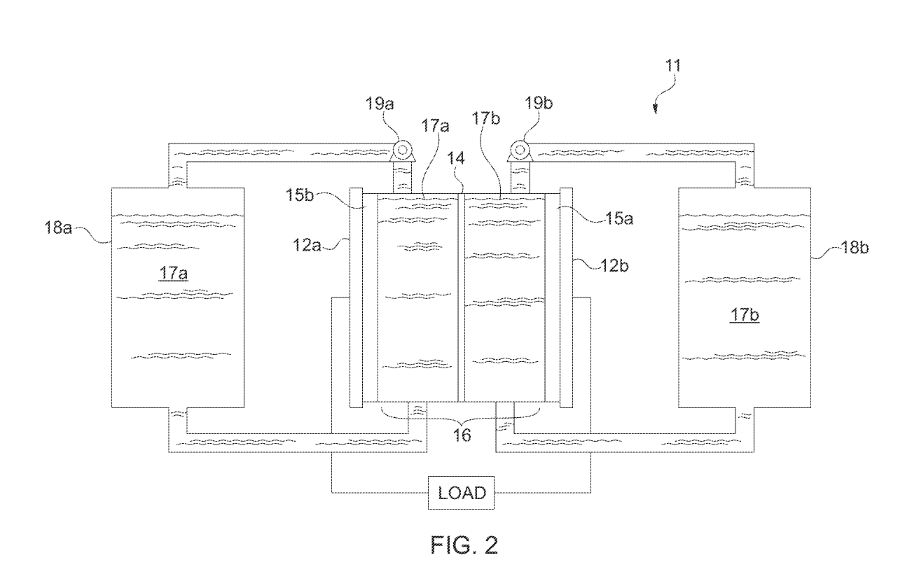

Referring now to FIG. 2, a schematic the composite electrode 10 being used with a typical flow battery stack system 11, in accordance with a preferred embodiment, is disclosed. FIG. 2 illustrates a typical flow battery cell stack architecture 11 arranged with the composite electrode 10. This battery cell stack architecture 11 is common and well known in the art, and is used as an example to illustrate the composite electrode 10. It is understood that one skilled in the art would easily and without undue experimentation apply the composite electrode 10 to any variety of battery cell stack architectures 11.

A simple battery cell stack architecture 11 comprises a membrane 14 with a positive electrode 15a (e.g., the composite electrode 10) disposed on one side of the membrane 14 and a negative electrode 15b (e.g., the composite electrode 10) disposed on the opposite side of the membrane 14. A first frame component 12a is shown here being placed adjacent to the negative electrode 15b, while a second frame component 12b is placed adjacent to the positive electrode 15a; however, other configurations may be utilized. When assembled, the frame components 12a, 12b create a flow compartment 16. A catholyte fluid 17a is contained within the catholyte tank 18a, which is in fluid communication with each negative electrode 15b via a catholyte pump 19a. An anolyte fluid 17b is contained within the anolyte tank 18b, which is in fluid communication with each positive electrode 15a via an anolyte pump 19b.

Each positive and negative electrode 15a, 15b could comprise the composite electrode 10. As shown in FIG. 1, the semi-porous reaction zone 50, and therefore the carbon felt 20, abuts the membrane 14. The porous flow path zone 40, and therefore the carbon foam 30, abuts a frame component 12a, 12b. In assembly, the frame components 12a, 12b are advanced towards each other to compress the constituent parts of the battery cell. Use of the composite electrode 10 results in approximately a 5% compression of the composite electrode 10 during assembly, whereas a carbon felt electrode generally experiences a 30% compression. This significantly reduces bulging effects during assembly of the cell stack.

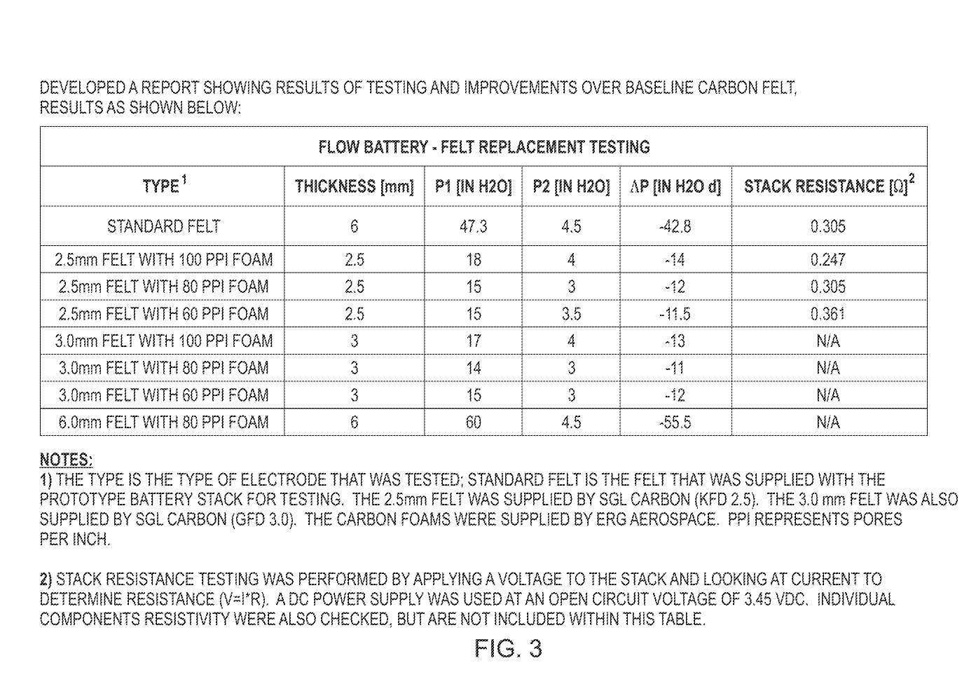

Furthermore, because the compression of the composite electrode 10 is not as extensive as that of carbon felt electrodes, the porous flow path zone 40 can sustain a high flux of electrolyte at lower feed pressures. In addition, the composite electrode 10 exhibits similar, if not better, electrical resistivity when compared to prior art carbon felt electrodes, as shown in FIG. 3, which shows a chart of flow battery carbon felt replacement data. This increases efficiency and performance of the flow battery system, as well as reduces the probability failures caused by leakage.

In an alternative embodiment, the composite electrode 10 is configured to exhibit at least eighty pores per inch within the porous flow path zone 40 when in a compressed state to provide superior flux through the porous flow path zone 40.

In an alternative embodiment, as shown in FIG. 1, a surface of the carbon foam 30 is provided with electrically conductive elements 70 to assist with electrical conductivity. These electrically conductive elements 70 are preferably graphene.

In an alternative embodiment, as shown in FIG. 1, the composite electrode 10 further comprises a current collector 60 disposed on a surface of the carbon foam 30. The current collector 60 is preferably a graphite material. In this embodiment, the composite electrode 10 can again be manufactured as three or more laminated layers or as a single piece through additive manufacturing or other manufacturing techniques.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range.

I/we claim:

1. A composite electrode adapted for use in a flow battery stack system, comprising:
an electrode having a semi-porous reaction zone and a porous flow path zone, wherein:
said semi-porous reaction zone comprises carbon felt; and
said porous flow path zone comprises carbon foam.

2. The composite electrode recited in claim 1, wherein said carbon felt comprises SGL Group carbon electrode felt.

3. The composite electrode recited in claim 1, wherein said carbon foam comprises Duecel® reticulated vitreous foam.

4. The composite electrode recited in claim 1, wherein said composite electrode is configured to exhibit at least eighty pores per inch within said porous flow path zone when said composite electrode is compressed within said flow battery stack system.

5. A composite electrode adapted for use in a flow battery stack system, comprising:
an electrode having a semi-porous reaction zone and a porous flow path zone, wherein:
said semi-porous reaction zone comprises carbon felt;
said porous flow path zone comprises carbon foam; and
a surface of said carbon foam is provided with electrically conductive elements.

6. The composite electrode recited in claim 5, wherein said carbon felt comprises SGL Group carbon electrode felt.

7. The composite electrode recited in claim 5, wherein said carbon foam comprises Duecel® reticulated vitreous foam.

8. The composite electrode recited in claim 5, wherein said composite electrode is configured to exhibit at least eighty pores per inch within said porous flow path zone when said composite electrode is compressed within said flow battery stack system.

9. The composite electrode recited in claim 5, wherein said electrically conductive elements are graphene.

10. A composite electrode adapted for use in a flow battery stack system, comprising:
an electrode having a semi-porous reaction zone and a porous flow path zone, wherein:
said semi-porous reaction zone comprises carbon felt;
said porous flow path zone comprises carbon foam; and
a surface of said carbon foam is provided with electrically conductive elements and a current collector.

11. The composite electrode recited in claim 10, wherein said carbon felt comprises SGL Group carbon electrode felt.

12. The composite electrode recited in claim 10, wherein said carbon foam comprises Duecel® reticulated vitreous foam.

13. The composite electrode recited in claim 10, wherein said composite electrode is configured to exhibit at least eighty pores per inch within said porous flow path zone when said composite electrode is compressed within said flow battery stack system.

14. The composite electrode recited in claim 10, wherein said electrically conductive elements comprise graphene.

15. The composite electrode recited in claim 10, wherein said current collector comprise graphite.
